(19) United States
(12) Patent Application Publication
(10) Pub. No.: US 2020/0115285 A1
(43) Pub. Date: Apr. 16, 2020

(54) LOW COST THERMALLY CONDUCTIVE CARBON FOAM FOR TOOLING AND OTHER APPLICATIONS

(71) Applicant: CFOAM LLC, Triadelphia, WV (US)

(72) Inventor: Rudolph A. Olson, III, Hendersonville, NC (US)

(73) Assignee: CFOAM LLC

(21) Appl. No.: 16/598,243

(22) Filed: Oct. 10, 2019

Related U.S. Application Data
(60) Provisional application No. 62/743,634, filed on Oct. 10, 2018.
(60) Provisional application No. 62/743,639, filed on Oct. 10, 2018.

(51) Int. Cl. C04B 35/536; C04B 38/00

(52) U.S. Cl. CPC C04B 35/536; C04B 38/0022; C04B 2235/9607; C04B 2235/422; C04B 38/0067

(57) ABSTRACT

A method for manufacturing a low cost thermally conductive carbon foam composite utilizing coal as a precursor, or starting material, and natural or synthetic graphite as a thermally conductive additive. Also, a method for manufacturing carbon foam at pressures at-or-near atmospheric pressure.

### CROSS-REFERENCE TO RELATED APPLICATIONS

The present invention claims priority to U.S. Provisional Patent Application Nos. 62/743,634, filed Oct. 10, 2018, and 62/743,639, filed Oct. 10, 2018; both incorporated herein by reference in their entirety.

### FIELD OF THE DISCLOSURE

The present invention is directed to a method for manufacturing a low cost thermally conductive carbon foam utilizing coal as a precursor, or starting material, and natural or synthetic graphite as a thermally conductive additive. Also disclosed is a method for manufacturing carbon foam at pressures at-or-near atmospheric pressure.

### BACKGROUND OF THE DISCLOSURE

Amorphous carbon foam can be created using coal as a precursor and a fully graphitic foam can be created using mesophase pitch as a precursor. In both manufacturing processes, the precursor is heated in a nitrogen (inert) filled atmosphere so that it does not burn. The precursor first melts as it is heated, then evolves gases that cause the material to foam. The foaming step is done under high pressure to help regulate bubble formation. As oxygen, nitrogen, and hydrogen are eliminated from the precursor during heat up, the carbon continues to cross-link until only an amorphous carbon material remains at 1000° C. In the case of graphite foam created from mesophase pitch, further heating induces nucleation and growth of graphite crystals.

Carbon foam is typically a strong, open cell, durable, stable, easily machined, and relatively unreactive lightweight material. Carbon foams are carbonaceous materials of very high carbon content that have appreciable void volume. As such, carbon foams are primarily comprised of elemental carbon. In appearance, excepting color, carbon foams resemble readily available commercial plastic foams. The void volume of carbon foams is located within numerous empty cells. The boundaries of these cells are defined by the carbon structure. These cells typically approximate ovoids of regular, but not necessarily uniform, size, shape, distribution, and orientation. The void volumes in these cells may directly connect to neighboring void volumes. Such an arrangement is referred to as an open-cell foam. The carbon in these foams forms a structure that is continuous in three dimensions across the material.

Altering mechanical characteristics of the final carbon foam product, such as the density, compressive strength, thermal conductivity, and the like requires altering the process parameters, such as the temperatures, pressures, and starting materials. By starting the manufacturing process from an admixture of a starting material and thermally conductive additive, the properties of the final carbon foam product can be altered without adding significant cost. Therefore, it is beneficial to produce a thermally conductive carbon foam to obtain these desirable properties.

### BRIEF SUMMARY OF THE INVENTION

The present invention is a method for producing a low cost thermally conductive carbon foam composite, comprising the steps of: adding a thermally conductive additive to a carbon foam starting material to form a thermally conductive admixture; and heating the admixture under controlled temperature and pressure sufficient to produce a thermally conductive carbon foam composite. Also, a thermally conductive carbon foam composite prepared by the method above is disclosed.

### BRIEF DESCRIPTION OF THE DRAWINGS

FIG. 1 illustrates carbon foam being machined into a complex shape for use as a composite device, such as a tool;

FIG. 2 illustrates cross-sections of autoclaved carbon foam made with 90 wt % White Forest coal and 10 wt % natural graphite heated to 470° C. at 100-psi in accordance with an embodiment of the invention;

FIG. 3 is a plot of thermal conductivity as a function of temperature for thermally conductive carbon foam composites having: 1) no thermally conductive additive; 1) 10 wt % natural graphite thermally conductive additive; and 2) 10 wt % synthetic graphite thermally conductive additive in accordance with embodiments of the invention;

FIG. 4 illustrates a cross-section of foam made at 50 psi. Note how a cavity begins to form and the foam starts to partially collapse.

FIG. 5 illustrates differential scanning calorimetry curves conducted at atmospheric pressure of Deep Mine 41 coal and mesophase pitch.

### DETAILED DESCRIPTION OF THE INVENTION

Some embodiments of the present invention are described in this section in detail sufficient for one skilled in the art to practice the present invention without undue experimentation. It is to be understood, however, that the fact that a limited number of preferred embodiments are described does not in any way limit the scope of the present invention as set forth in the claims.

It is to be understood that whenever a range of values is described herein, i.e. whether in this section or any other part of this patent document, the range includes the end points and every point there between as if each and every such point had been expressly described. Unless otherwise stated, the words “about” and “substantially” as used herein are to be construed as meaning the normal measuring and/or fabrication limitations related to the value or condition which the word “about” or “substantially” modifies. Unless expressly stated otherwise, the term “embodiment” is used herein to mean an embodiment of the present invention. The term “mold”, as used herein is meant to define a mechanism for providing controlled dimensional forming of the expanding coal. Thus, any chamber into which the admixture is deposited prior to or during heating and which, upon the coal powder attaining the appropriate expansion temperature, contains and shapes the expanding porous coal to some predetermined configuration such as: a flat sheet; a curved sheet; a shaped object; a building block; a rod; tube or any other desired solid shape can be considered a “mold” for purposes of the instant invention.

Amorphous carbon foam is often used as a tooling material in the manufacture of carbon fiber composite parts. It is easily machined, light weight, has acceptable strength, and a relatively low coefficient of thermal expansion similar to that of most carbon fiber composites. To create a tool, blocks of carbon foam are initially bonded together to make a large monolith. Secondly, the large monolith is machined roughly to the shape desired. Lastly, the carbon foam is surfaced with an appropriate material and machined again to exact specifications. The tool is then ready to be used as a form to make carbon fiber composite parts.

A method for manufacturing thermally conductive carbon foam utilizing coal as a starting material, or precursor, and natural or synthetic graphite as a thermally conductive additive is described below. The method delivers a more thermally conductive carbon foam that enables improved autoclave processing of a composite part by increasing the speed of heat-up and cool-down of the tool used to support the composite part, which makes up most of the mass in the system. Autoclave processing is a high cost in the composite manufacturing process and process speed through it can limit the production capacity of the plant. Having a tool with higher thermal conductivity allows the composite device to be heated and cooled faster, which would significantly reduce cost and increase plant throughput.

Another advantage includes reduced thermal stress on the composite device. A composite device, such as a tool, develops stress when being heated and cooled through an autoclave cycle due to the development of thermal gradients. The higher the thermal conductivity of the composite device, the lesser the thermal gradient that develops for a given autoclave profile and the lesser the stress. Thus, having a higher thermal conductivity will reduce the risk of a composite device failing when heated in an autoclave.

Still further, another advantage includes enabling the use of lighter foam starting material having a lesser strength. The thermal stress imposed on the composite device is reduced with higher thermal conductivity, therefore the strength it requires to inhibit failure via thermal stress is also lessened. This in turn means a lower density carbon foam can be used to construct the composite device, which has the added advantage of reducing the overall weight of the composite device. The energy required to heat the lesser mass is also reduced.

Additionally, higher thermal conductivity carbon foam, in accordance with embodiments of the present invention, provides a more uniform surface temperature. One of the challenges in manufacturing composite parts is being able to uniformly heat the tool such that the resin component of the composite that sits on its surface cures very uniformly. When the tool has higher thermal conductivity, the thermal gradients at the surface of the composite device are reduced, thus improving the temperature uniformity of the composite part and ultimately enabling the construction of a more structurally sound composite part.

Carbon foams have been produced by a variety of methods and starting materials. Some of these methods include producing carbon foams directly from particulate coal. For example, U.S. Pat. Nos. 6,749,652; 6,814,765; and 7,588,608; each herein incorporated by reference in their entirety, describe methods for producing carbon foam directly from particulate coal. To produce carbon foam from particulate coal, typically, a suitable swelling coal, such as bituminous coal, is heated in an essentially closed vessel. The particulate coal is placed in a mold and heated in an inert atmosphere under process atmospheric pressures typically greater than ambient and can reach pressures of about 500 psig or greater. The particulate coal is heated to temperatures sufficient to cause the coal to become plastic and swell, forming a carbon foam. In many instances, heating the particulate coal to a temperature between about 300° C. and about 500° C. is sufficient to form a carbon foam material. The temperatures and pressure conditions will vary depending upon the characteristics of the particulate coal. The resultant carbon foam may subsequently be heated under an essentially inert or otherwise non-reactive atmosphere to temperatures as great as about 3000° C. Heating of the carbon foam to such elevated temperatures has been found to improve certain properties of the foam. Such properties have included, but are not limited to, electrical resistance, thermal conductivity, thermal stability, and strength. Often processing carbon foam to such high temperatures is cost prohibitive when considering commercial applications, such as tooling for composite part manufacture.

During heating, the particles begin to melt and evolve gases that cause the material to foam. The foaming step is done under high pressure to help regulate bubble formation. As oxygen, nitrogen, and hydrogen are eliminated from the precursor during heat up, the carbon continues to cross-link until only an amorphous carbon material remains at 1000° C.

Manufacture of graphitized carbon foam using mesophase pitch follows a similar manufacturing process, but its use as a tooling material for composite part production is cost prohibitive due to the high price of the mesophase pitch (>$16 per pound) and the high temperatures required to achieve significant growth of graphite within the body (>2600° C.). It also does not have sufficient strength for this application. Using a mixture of commercially available graphite powder with coal reduces cost of raw materials to an acceptable level, reduces processing temperature to a level that enables cost effective manufacture of carbon foam for tooling, and produces a material with sufficient mechanical strength.

Typically, the cells in carbon foams are of a size that is readily visible to the unaided human eye. Also, the void volume of carbon foams is such that it typically occupies much greater than one-half of the carbon foam volume. The density of carbon foams is typically less than about 1.0 g/cc and generally less than about 0.8 g/cc. In some embodiments, the density for carbon foam may range from about 0.05 g/cc to about 0.8 g/cc. In some embodiments, carbon foams may exhibit compressive strengths ranging up to about 10,000 psig. In other embodiments, the compressive strength for carbon foam may range from about 50 psig to about 10,000 psig. In certain other embodiments, compressive strengths for carbon foam may range from about 400 psig to about 7,000 psig.

A carbon foam composite device made from a starting material and admixed with a thermally conductive additive can have a density from about 0.2 to about 0.8 g/cc, preferably from about 0.3 to about 0.7 g/cc and most preferably from about 0.4 to about 0.5 g/cc. The starting material can be powdered coal particulate preferably less than about 0.1 inch in diameter, then admixed with a thermally conductive additive to form a thermally conductive admixture, and processed by controlled heating of the thermally conductive admixture in a “mold” under a non-oxidizing atmosphere. The starting material coal may include bitumen, anthracite, or even lignite, or blends of these coals that exhibit a “free swell index” as determined by ASTM D720 of between about 3.5 and about 5.0, but are preferably bituminous, agglomerating coals that have been comminuted to an appropriate particle size, preferably to a fine powder below about −60 to −80 mesh. Such a blend may first be slurrified and then spray dried to form spherical particulate to produce a more homogeneous mix of materials; the resultant spherical particles would improve particle flow and reduce dust. Additionally, according to further preferred embodiments of the present invention, the coal starting materials of the present invention possess all or at least some of the following characteristics: 1) a volatile matter content (dry, ash-free basis) of between about 35% and about 45% as defined by ASTM D3175, “Test Method for Volatile Matter in the Analysis of Coal and Coke”; 2) a fixed carbon (dry basis) between about 50% and about 60% as defined by ASTM D3172, “Practice for Proximate Analysis of Coal and Coke”; 3) a Gieseler initial softening temperature of between about 380° C. and about 400° C. as determined by ASTM D2639, Test Method for Plastic Properties of Coal by the Constant-Torque Gieseler Plastometer“; 4) a plastic temperature range above about 50° C. as determined by ASTM D2639; 5) a maximum fluidity of at least 300 ddpm (dial divisions per minute) and preferably greater than about 2000 ddpm as determined by ASTM D2639; 6) expansion greater than about 20% and preferably greater than about 100% as determined by Arnu Dilatation; 7) vitrinite reflectance in the range of from about 0.80 to about 0.95 as determined by ASTM D2798, “Test Method for Microscopical Determination of the Reflectance of Vitrinite in Polished Specimens of Coal”; 8) less than about 30% inert maceral material such as semifusinite, micrinite, fusinite, and mineral matter as determined by ASTM D2798; and 9) no significant oxidation of the coal (0.0 vol % moderate or severe oxidation) as determined by ASTM D 2798 and non-maceral analysis. The low softening point (380-400° C.) is important so that the material softens and is plastic before volatilization and coking occur. The large plastic working range or “plastic range” is important in that it allows the coal to flow plastically while losing mass due to volatilization and coking. Vitrinite reflectance, fixed carbon content, and volatile matter content are important in classifying these coal starting materials as “high-volatile” bituminous coals that provide optimum results in the process of the present invention and thus, carbon foam materials that exhibit an optimum combination of properties when prepared in accordance with the process described and claimed herein. The presence of oxidation tends to hinder fluidity and consequently, foam formation.

Thus, according to various embodiments of the present invention, a coal particulate starting material characterized as a high-volatile bituminous coal containing from about 35% to about 45% by weight (dry, ash-free basis) volatile matter, as defined by ASTM D3175, is a basic requirement for obtaining optimum results in the form of optimum carbon foaming in accordance with the process of the present invention. The various parameters derived from the Gieseler plasticity evaluations form the second highly important set of characteristics of the starting material coal if optimum results are to be obtained. Thus, a softening point in the range of from about 380° C. and about 400° C., a plastic range of at least about 50° C. and preferably between about 75 and 100° C., and a maximum fluidity of at least several hundred and preferably greater than 2000 ddpm (dial divisions per minute) are highly important to the successful optimized practice of the present invention. Accordingly, in order to obtain the carbon foams exhibiting the superior properties described herein, it is important that the coal starting material be a high volatile bituminous coal having a softening point as just described and a plastic range on the order of above about 50° C. all with the indicated Gieseler fluidity values described. Exhibition of Arnu dilatation values greater than about 20% and preferably above about 100% when combined with the foregoing characteristics provide indications of a highly preferred high volatile bituminous coal starting material.

The cellular coal-based products described herein are semi-crystalline or more accurately turbostratically-ordered and largely isotropic, i.e., demonstrating physical properties that are approximately equal in all directions. The cellular coal-based products typically exhibit pore sizes on the order of less than 400 μm, although pore sizes of up to 700 μm are possible within the operating parameters of the process described. The thermal conductivity of cellular carbon foam manufactured from coal is generally less than about 0.6 W/m-K at ambient temperature without the thermally conductive additive. Typically, the cellular coal-based products of the present invention demonstrate compressive strengths on the order of from about 1500 to about 3000 psig at densities of from about 0.4 to about 0.5 g/cc. The coal starting material can exhibit the previously specified free swell index of between about 3.5 and about 5.0 and preferably between about 3.75 and about 4.5. Selection of starting materials within these parameters was determined by evaluating a large number of coals characterized as ranging from high to low volatiles. In general, it has been found that bituminous coals exhibiting free swell indices within the previously specified ranges provided the best foam products in the form of the lowest calcined foam densities and the highest calcined foam specific strengths (compressive strength/density). Such bituminous coals that also possess the foregoing set of properties, high volatile content (35% to 45% by weight), large plastic range (at least about 50° C.), etc., and are thus characterized as high volatile bituminous coals, are the preferred starting materials for the process of the present invention. Coals having free swell indices below the specified preferred ranges may not agglomerate properly leaving a mass of sintered particles, but not swell or foam, while coals exhibiting free swell indices above these preferred ranges may heave upon foaming and collapse upon themselves leaving a dense compact.

The production method of the present invention comprises: 1) heating a high volatile bituminous coal admixture of preferably small particle size, i.e., less than about 100-μm, in a “mold” and under a non-oxidizing atmosphere at a heat up rate of from about 0.1 to about 20° C. per minute to a temperature of between about 300 and about 700° C.; 2) soaking at a temperature of between about 300 and 700° C. for about 10 minutes up to about 12 hours to form a preform or finished product; and 3) controllably cooling the preform or finished product to a temperature below about 100° C. The non-oxidizing atmosphere may be provided by the introduction of inert or non-oxidizing gas into the “mold” at a pressure of from about 0 psig, i.e., free flowing gas, up to about 500 psig. The inert gas used may be any of the commonly used inert or non-oxidizing gases such as nitrogen, helium, argon, etc.

It is generally not desirable that the reaction chamber be vented or leak during the heating and soaking operation. The pressure of the chamber and the increasing volatile content therein tends to retard further volatilization while the cellular product sinters at the indicated elevated temperatures. If the furnace is vented or leaks during soaking, an insufficient amount of volatile matter may be present to permit inter-particle sintering of the coal particles, thus resulting in the formation of a sintered powder as opposed to the desired cellular product. Thus, according to a preferred embodiment of the present process, venting or leakage of non-oxidizing gas and generated volatiles is inhibited, consistent with the production of an acceptable cellular product. Additionally, more conventional blowing agents may be added to the particulate prior to expansion to enhance or otherwise modify the pore-forming operation.

As the mold pressure increases from 0 psig to 500 psig, as imposed by the non-oxidizing gas, the reaction time will increase and the density of the thermally conductive admixture will increase as the size of the “bubbles” or pores produced in the expanded coal decreases. Similarly, a low soak temperature at, for example, about 400° C. will result in a larger pore or bubble size and consequently a less dense expanded coal than would be achieved with a soak temperature of about 600° C. Further, the heat-up rate will also affect pore size, a faster heat-up rate resulting in a coarser pore size and consequently a less dense expanded coal product than a slow heat-up rate. These phenomena are, of course, due to the kinetics of the volatile release reactions which are affected, as just described, by the ambient pressure and temperature and the rate at which that temperature is achieved. These process variables can be used to custom produce the expanded coals of the present invention in a range of controlled densities and pore sizes.

Cooling of the preform or product after soaking is not particularly critical except as it may result in cracking of the preform or product as the result of the development of undesirable thermal stresses. Cooling rates less than 10° C./min to a temperature of about 100° C. are typically used to prevent cracking due to thermal shock. The rate of cooling below 100° C. does not influence the final product.

After expanding, the porous coal-based preform or product, i.e. carbon foam in accordance with the present invention, is readily machineable, sawable, and otherwise readily fabricated using conventional fabrication techniques. Subsequent to production of the preform or product as just described, the preform or product may be subjected to carbonization according to conventional processes to obtain particular properties desirable for specific applications of the type described hereinafter. Ozonation may also be performed, if activation of the coal-based expanded product would be useful in a final product application such as in filtering of air.

The open-cell, coal-based preforms or products, i.e. carbon foams, of the present invention can additionally be impregnated with, for example, petroleum pitch, epoxy resins or other polymers using a vacuum assisted resin transfer type of process. The incorporation of such additives provides load transfer advantages similar to those demonstrated in carbon composite materials. In effect, a 3-D composite is produced that demonstrates enhanced impact resistance and load transfer properties.

Carbonization, sometimes referred to as calcining, is conventionally performed by heating the preform or product under an appropriate inert gas at a heat-up rate of less than about 5° C. per minute to a temperature between about 800° C. and about 1200° C. and soaking for from about 1 hour to about 3 or more hours. Appropriate inert gases are those described above that are tolerant of these high temperatures. The inert atmosphere is supplied at a pressure from about 0 psig up to a few atmospheres. The carbonization/calcination process serves to transform any remaining organic elements bearing oxygen and/or hydrogen that are present in the preform or product to amorphous carbon. Note that most coals will not graphitize much, even at these high temperatures, because the polymers that coal is generally composed of will not align properly during the foaming and carbonation steps to nucleate graphite crystals.

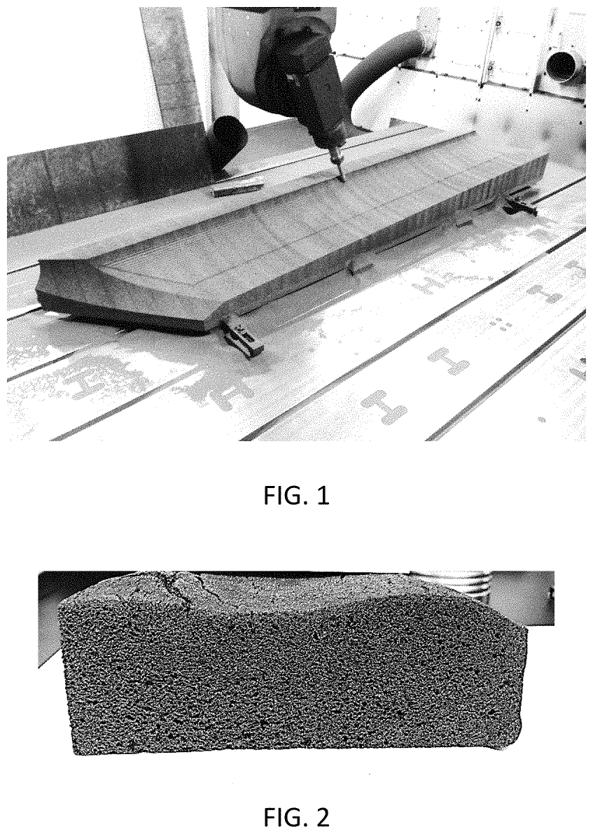

A thermally conductive carbon foam composite (TCCFC) material and device can be manufactured from a carbon foam using coal and thermally conductive additive as the precursor starting materials. Composite devices, such as tools, made using TCCFC can be very large and thick; on the order of a few to dozens of feet in length. The TCCFC device is often bonded and then machined into complex shapes that then serve to make complex composite shapes, as shown in FIG. 1. The TCCFC device has many attractive properties, such as: low coefficient of thermal expansion in the range of about 2×10⁻⁶ in/in/° C. to about 8×10⁻⁶ in/in/° C., preferably about 5×10⁻⁶ in/in/° C.; high machinability; and good stability at high temperatures. Without the thermally conductive additive, a carbon foam made from only coal as a starting material has a thermal conductivity between about 0.25-0.5 W/m-K, which can be a disadvantage when compared to composite device materials such as Invar (12-15 W/m-K).

During heating, the coal particles begin to melt and evolve gases that cause the material to foam. The foaming step can be done under high pressure to help regulate bubble formation. As oxygen, nitrogen, and hydrogen are eliminated from the precursor during heat up, the carbon continues to cross-link until only an amorphous carbon material remains at 1000° C.

TCCFC devices are also subjected to a thermal process when curing a composite part on its surface. Consequently, the rate at which heat travels through the composite device becomes an important parameter. For the reasons stated above, there is a desire to increase the rate at which heat travel through the carbon foam. Improved thermal conductivity enables improved properties and performance of the carbon foam material.

TCCFC devices may also be used as heat exchangers, where it is desirable to transfer heat as quickly as possible from the foam structure to the fluid within the pores and vice versa. Increasing the thermal conductivity of the carbon foam at a reasonable cost is attractive in applications requiring heat exchange.

The thermally conductive additive can be both natural and synthetic graphite, which are relatively low density materials having about 2.1 g/cc to about 2.3 g/cc density, and with high thermal conductivity of about 200-350 W/m-K, depending on crystal structure and purity. Natural and synthetic graphite are also carbon based and relatively inert. In addition, they have a high aspect ratio with their platelet shape, so they have a greater impact on increasing thermal conductivity per unit volume when added to a matrix having lower thermal conductivity. To be more specific, when adding spheres to such a matrix, it typically takes about 18-20 volume percent to reach the percolation limit, where the spheres are then connected from one size of the object to the other. When adding platelets, the percolation limit can be usually achieved closer to 10-15 percent. When using fibers or needles, it usually requires less than 10 volume percent.

A thermally conductive carbon foam (TCCFC) can be produced by adding a thermally conductive additive such as natural or synthetic graphite to the comminuted coal starting material prior to the foaming process. In some embodiments, about 3% to about 25% by weight natural or synthetic graphite can be added to comminuted coal starting material prior to the foaming process described above. In certain embodiments, the natural or synthetic graphite may range from about 3% to about 15% by weight, and in some embodiments may be at least about 10% by weight. The comminuted coal starting material can be admixed with the particulate natural or synthetic graphite to form a thermally conductive admixture, and then placed in a mold which can be heated in an inert atmosphere under process atmospheric pressures typically greater than ambient and can reach pressures of about 500 psig or greater. The thermally conductive admixture can be heated to temperatures sufficient to cause the coal starting material to become plastic and swell, forming a carbon foam. In many instances, heating the thermally conductive admixture to a temperature between about 300° C. and about 500° C. can be sufficient to form the thermally conductive carbon foam material. The temperatures and pressure conditions will vary depending upon the characteristics of the particulate coal starting material. The resultant thermally conductive carbon foam may subsequently be heated under an essentially inert, or otherwise non-reactive atmosphere to temperatures as great as about 3000° C. Heating of the thermally conductive carbon foam to such elevated temperatures has been found to improve certain properties of the foam. Such properties have included, but are not limited to, electrical resistance, thermal conductivity, thermal stability, and strength.

The thermally conductive additive is not limited to graphite. Other high thermal conductivity materials that can withstand the processing temperatures of carbon foam (over 1000° C.) could be utilized, including but not limited to, thermally conductive carbon fiber, metal fiber or particles (e.g. copper, steel, beryllium, silver), or thermally conductive ceramic fiber or particles (e.g. aluminum nitride, silicon carbide, boron nitride).

The resultant thermally conductive carbon foam composite (TCCFC) exhibits thermal conductivity greater than about 1 W/m-K at ambient temperature, and in some embodiments greater than about 1.5 W/m-K at ambient temperature.

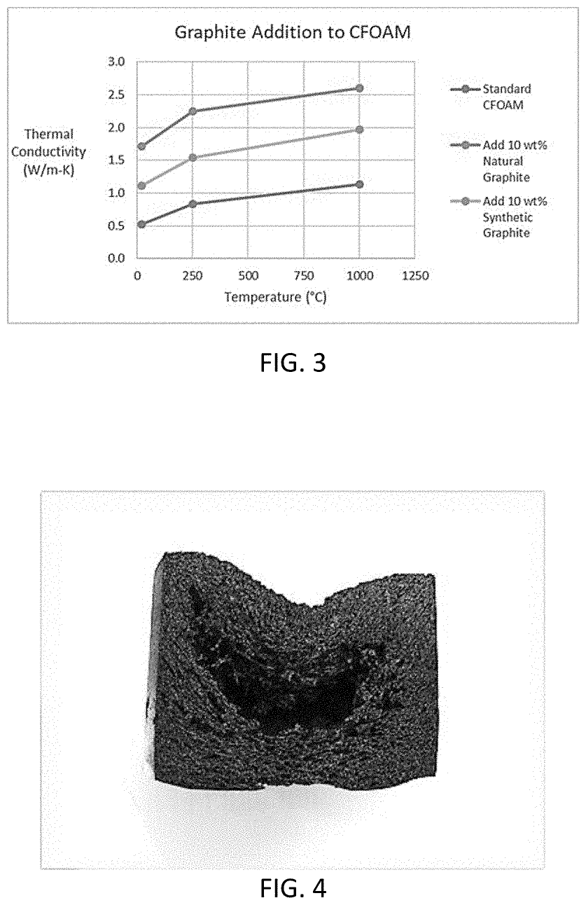

Example: Small pucks of thermally conductive carbon foam were produced having 10 wt % graphite. As seen in FIG. 2, the thermally conductive carbon foam structure formed nicely and the tensile strength averaged over 500 psig. FIG. 3 is a plot of thermal conductivity as a function of temperature for thermally conductive carbon foam composites having: 1) no thermally conductive additive (bottom line); 2) 10 wt % synthetic graphite thermally conductive additive exhibiting thermal conductivities in the range of about 1.0 W/m-K to about 10 W/m-K (middle line); and 3) 10 wt % natural graphite thermally conductive additive exhibiting thermal conductivity in the range of about 1.7 W/m-K to about 2.6 W/m-K (top line). The thermal conductivity is increased by a factor of two at typical composite processing temperatures (25-250° C.) when utilizing synthetic graphite, and a factor of three when utilizing natural graphite (received from Carbon Graphite Materials in Pennsylvania). These are significant improvements in thermal conductivity and will have a large impact on the performance of TCCFC composite devices.

Additionally, carbon foam can be manufactured in near-atmospheric pressure conditions. Typically, the heating (foaming) step is done under high pressure (about 400 psig or 27 times atmospheric pressure) to help regulate the rate at which the precursor transforms into liquid phase, forms bubbles, and crosslinks to form a solid foam. This foaming step can be performed over a temperature range of about 25-470° C.; oxygen, nitrogen, and some hydrogen are eliminated. The foamed product can be then fired in a kiln at atmospheric pressure under nitrogen to eliminate most of the remaining hydrogen and further crosslink the carbon until only a glassy carbon material remains at 1000° C.

Having to form the foam in an autoclave at high pressure is expensive, time consuming, capital intensive, dangerous, and limited to a batch-type operation. In addition, the size of the product is limited to the size of the autoclave that is allowed by the process conditions, or the size autoclave that a business can afford. The higher the pressure, the more expensive the autoclave and the more the size is limited by engineering constraints.

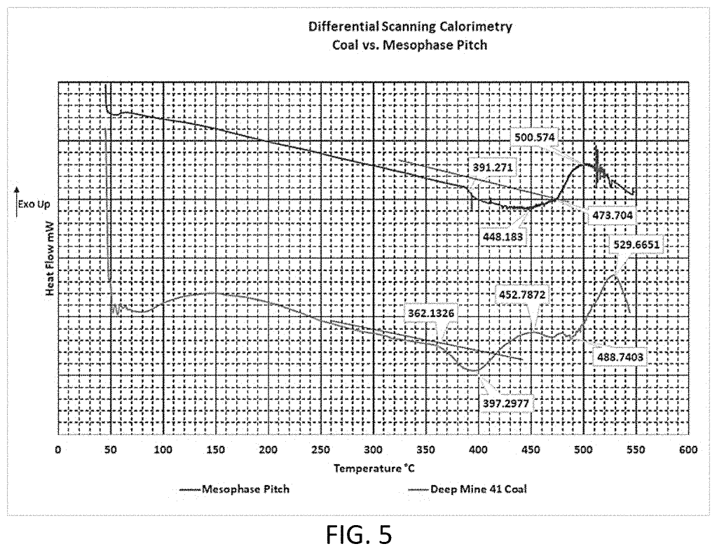

Carbon foam of a relatively uniform pore size cannot be manufactured at lower pressures because the bubbles tend to breakdown and coarsen, forming large cavities on the inside of the product, as shown in FIG. 4. The size of the cavities tend to get larger as the pressure at which foaming is performed is decreased. One explanation as to why carbon foam cannot be made at low pressure is because the coal reacts more rapidly as pressure is decreased, creating a thermal gradient from inside to outside that induces the structural problem within the foam. FIG. 5 shows the total reaction of the coal proceeding to amorphous carbon is ultimately exothermic to 550° C. It is also known that cavities tend to form even at high pressure when the heating rate is too fast, so it appears the mechanism by which the foam fails by a fast heating rate can be similar to the same failure mechanism at low pressure production.

We believed if we could make the material more thermally conductive such that heat could not build in the center of the part due to the faster reaction rate of the coal, then the internal temperature of the foam would be regulated and a defect-free structure can result.

FIG. 2 shows the result of adding 10 wt % natural graphite to White Forest coal, which is a much higher thermally conductive additive compared to coal. Note the pore structure looks relatively uniform throughout the middle. At the least, this concept allows one to use autoclaves designed for lower pressures, which are much lower cost and capable of being built to much larger sizes. It would possibly allow one to make relatively thick sections of carbon foam at atmospheric pressure.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

1. A method for producing a thermally conductive carbon foam composite, comprising the steps of:
adding a thermally conductive additive to a carbon foam starting material to form a thermally conductive admixture; and
heating the admixture under controlled temperature and pressure sufficient to produce a thermally conductive carbon foam composite.

2. The method of claim 1, wherein the carbon foam starting material comprises coal particulate, mesophase pitch, and mixtures thereof.

3. The method of claim 1, wherein the starting material comprises a high-volatile coal of bitumen, anthracite, lignite, and mixtures thereof, comprising about 35% to about 45% by weight volatile matter.

4. The method of claim 1, wherein the thermally conductive additive comprises natural graphite, synthetic graphite, thermally conductive carbon fiber, copper, steel, beryllium, silver, aluminum nitride, silicon carbide, boron nitride, and mixtures thereof.

5. The method of claim 1, wherein the coefficient of thermal expansion of the thermally conductive carbon foam composite is in the range of about 2×10⁻⁶ in/in/° C. to about 8×10⁻⁶ in/in/° C., preferably about 5×10⁻⁶ in/in/° C.

6. The method of claim 1, wherein the density of the thermally conductive additive is in the range of about 2.1 g/cc to about 2.3 g/cc.

7. The method of claim 1, wherein the thermal conductivity of the thermally conductive additive is in the range of about 200 W/m-K to about 350 W/m-K.

8. The method of claim 1, wherein the thermal conductivity of the thermally conductive carbon foam composite is in the range of about 1.0 W/m-K to about 10 W/m-K.

9. The method of claim 1, wherein the thermal conductivity of the thermally conductive carbon foam composite is in the range of about 1.7 W/m-K to about 2.6 W/m-K

10. The method of claim 1, wherein the thermally conductive admixture comprises about 3% to about 25% by weight, preferably about 3% to about 15% by weight, and more preferably at least about 10% by weight of the thermally conductive additive.

11. The method of claim 1, wherein the heating step is performed at a temperature between about 300° C. and about 500° C.

12. The method of claim 1, wherein the heating step is performed in a non-oxidizing atmosphere at a heat up rate of about 0.1° C. to about 20° C. per minute.

13. The method of claim 1, wherein the heating step is performed in a non-oxidizing atmosphere at a pressure of between about 0 psig to about 500 psig.

14. The method of claim 1, further comprising; soaking the thermally conductive composite at a temperature of between 300° C. and 700° C. for about 10 minutes to about 12 hours.

15. The method of claim 1, further comprising; controllably cooling the thermally conductive carbon foam composite to a temperature below about 100° C.

16. The method of claim 1, further comprising; carbonizing and graphitizing the thermally conductive admixture.

17. A thermally conductive carbon foam composite prepared by the process comprising the steps of:
adding a thermally conductive additive to a carbon foam starting material to form a thermally conductive admixture; and
heating the admixture under controlled temperature and pressure sufficient to produce a thermally conductive carbon foam composite.
